(19) United States
(12) Patent Application Publication
(10) Pub. No.: US 2004/0046792 A1
(43) Pub. Date: Mar. 11, 2004

(54) Application training simulation system and methods

(75) Inventors: Paul D. Coste, Nashua, NH (US); Annette J. DiLello, Littleton, MA (US)

Correspondence Address: TESTA, HURWITZ & THIBEAULT, LLP, HIGH STREET TOWER, 125 HIGH STREET, BOSTON, MA, 02110, US

(73) Assignee: Knowledge Impact, Inc., Wayland, MA (US)

(21) Appl. No.: 10/238,030

(22) Filed: Sep. 9, 2002

(51) Int. Cl. G09G 5/00

(52) U.S. Cl. 345/763

(57) ABSTRACT

A system and methods to facilitate the creation of training simulations for computer applications. Creating a training simulation involves capturing information from a software application for which a training simulation is being built while the application is executing. The information that is captured includes screen images of the application, information on the controls or user interface elements that appear on the screens, and information on the events or actions taken by a user of the application. This information is analyzed, and used in visual tool that allows a course developer to create and edit highly interactive training simulations, having multiple paths within the simulations. The visual tool also permits a course developer to add training text and feedback to training simulations. Training simulations may be used by end users through a Web browser or other software capable of executing the training simulations.

### TECHNICAL FIELD

The invention generally relates to a system and methods for developing and displaying training simulations for software applications. More particularly, the invention relates to visual tools for creating highly interactive training applications from information captured during the execution of the application to be simulated, and software to play back such training simulations.

### BACKGROUND

The capabilities and complexity of software applications, from large-scale commercial applications to custom applications built for particular businesses or industries, is always increasing. To make effective use of the various software applications that are available, most users need training or instruction in using these applications. To address this need, many companies offer training software that teaches users to use particular applications.

In many cases this training software takes the form of an application training simulation, in which a user is instructed on how to perform a task, and is then asked to actually perform the task in a very limited simulation of the application on which the user is being trained. Typically, the screens of these limited simulations consist of little more than a screen image taken from the software application, with a single “hot area” defined on the screen to react to the user taking an action in the “hot area”. For example, on the screen of such a simulation, the area over the image of a button on the screen may be programmed to cause the simulation to react when the user clicks his mouse over that area of the screen.

Unfortunately, such simple simulations do not provide users with much freedom to explore the applications on which they are being trained. The screens of such simulations are typically images, with no actual working controls or other objects. The “hot areas” on the screen of such simulations typically do not react in the manner in which an actual control or other object in the actual application would react, since they do not have all of the properties and functionality of the actual user interface of the application. Users are typically limited to taking only the action that they have been instructed to take, and are unable to stray from the linear path through the simulation that has been dictated by the course developer.

More complex training simulations, that allow a greater degree of freedom have been built. Typically, such highly interactive simulations require that the screens of the simulation be completely rebuilt by the course developer, to include working versions of the various user interface objects or controls that appear on the screen. Such simulations are usually built using conventional programming or multi-media development tools, and require a high degree of skill, including programming skill, to construct. There are no easy-to-use visual tools for constructing such complex, highly interactive application simulations.

Because of the programming that may be needed, the skills required to build training simulations are often different than the skills possessed by the people who actually use the applications regularly. Building training simulations often requires the skills of a trainer, an expert in the application, and a programmer or multi-media developer. The need for this expertise, and the difficulty of building highly interactive training simulations greatly increases the time and expense of building such simulations. For many small, custom applications, the time and expense required to build a highly interactive training simulation may discourage the creation of such simulations.

### SUMMARY OF THE INVENTION

In view of the foregoing, an easy-to-use visual tool for creating highly interactive application training simulations would be desirable. Such a tool would preferably provide a way to create reasonably complete simulations of the user interfaces of applications with a minimum amount of development or programming. The present invention provides a system and methods that meet these needs by providing a tool that captures information from an application for which a training simulation is being built, including screen images of the application, information related to the controls or user interface elements that appear on the screens, and information related to the events or actions taken by a user of the application. This information is then analyzed, and used in a visual tool that allows a course developer to create and edit highly interactive simulations, having multiple paths within the simulations. These training simulations may be used by end users through a Web browser or other software capable of executing the simulations.

In one aspect, the invention provides a method of authoring a software training simulation that includes capturing a first image of a screen of a software application, capturing a control, having properties, the control appearing on the screen of the software application, capturing a stream of events occurring within the software application, and associating training text with the first image.

In some embodiments, the method includes analyzing the stream of events to extract a high-level event. Certain such embodiments include capturing a second image of a screen of the software application. In some embodiments, capturing the stream of events includes capturing zero or more events that occur between capturing the first image and capturing the second image.

Some embodiments include creating a path between the first image and the second image, where the path includes the high-level event. In some embodiments, the path is specified using a graphical user interface. Certain embodiments include adding a second path between the first image and the second image. Some embodiments of the invention further include capturing a third image of a screen of the software application, and creating a second path between the first and third images.

In some embodiments, associating training text with the first image includes associating a user prompt with the first image. Certain such embodiments further include associating one or more feedback texts with the first image.

In some embodiments, associating the training text with the first image includes associating multimedia with the first image.

In some embodiments, associating training text with the first image includes associating training text with the control. In some embodiments, associating training text with the first image includes associating training text with an event.

Some embodiments include associating a flow with the software training simulation, the flow including the first image, the control, and the training text. The flow is at least partially derived from an event in the stream of events.

Some embodiments include associating a scenario text with the software training simulation.

Some embodiments include editing a property of the control, and some embodiments include adding a second control having one or more properties. Some embodiments include saving the first image, the control, and the training text in a file.

In another aspect, the present invention provides a method of training a user to use a software application using a simulation of the software application. This method includes displaying a first image showing a screen of the software application, displaying a first control and a second control, each of which includes one or more properties, over the first image, displaying a training text associated with the first image, and permitting the user to perform a first action using the first control and a second action using the second control. The method further includes displaying a second image of the screen of the software application when the user performs the first action, and displaying a third image of the screen of the software application when the user performs the second action.

In some embodiments, displaying the training text includes displaying a user prompt that directs the user to perform a task, and displaying a feedback message if the user performs the task incorrectly. Some embodiments include executing a recorded event that alters the state of the first control when the event is executed to show the user how to perform a task.

In some embodiments the first image is displayed in a Web browser. Certain of such embodiments use a Java applet to display the first image.

In some embodiments displaying the training text includes displaying a scenario text prior to displaying the first image. In some embodiments, the scenario text may be displayed in response to a user request.

In certain embodiments, the method includes reporting information relating to the progress of a user.

In another aspect, the invention provides a method of training a user to use a software application using a simulation of the software application that includes displaying a first image showing a screen of the software application, displaying a first control, which includes one or more properties, over the first image, displaying a training text associated with the first image, and permitting the user to perform a first and second actions using the first control. The method further includes displaying a second image of the screen of the software application when the user performs the first action, and displaying a third image of the screen of the software application when the user performs the second action.

In another aspect, the invention provides a method of training a user to use a software application using a simulation of the software application, including displaying a scenario text associated with the simulation of the software application, displaying a first image showing a screen of the software application, displaying a first control, which includes one or more properties, over the first image, displaying a training text associated with the first image, and permitting the user to perform a first action using the first control.

In another aspect, the invention provides a system for creating a software training simulation. The system includes a capture tool that provides a content developer with an ability to sequentially capture one or more images of screens of a software application, to capture controls associated with each of the one or more images, and to capture a stream of events that occur during use of the software application. The system also includes an author tool that provides the content developer with an ability to associate training text with each of the images and to create one or more paths between the images. These paths may be based on events in the stream of events that affect at least one of the controls that are associated with the images.

In another aspect, the invention provides a system for creating a software training simulation that includes a capture tool that provides a content developer with an ability to sequentially capture one or more images of screens of a software application, to capture controls associated with each of the one or more images, and to save a representation of the controls, including properties associated with each control to a file. The system also includes an author tool that provides the content developer with an ability to read a file containing a representation of the plurality of controls and the properties associated with the controls, associate training text with each of the images, and to create one or more paths between the images. These paths may be based on actions that use the controls that are associated with the images.

In another aspect, the invention provides a software tool for capturing information from a software application for use in creating a training simulation for the software application. The software tool includes instructions that cause a computer to capture a first image of a screen of a software application, capture one or more controls located on the screen of the software application, each of the controls including properties, and save information on the image, the controls, and the properties for use in creating a training simulations.

In some embodiments, the instructions also cause the computer to capture a stream of events that occur during use of the software application. In some embodiments, the instructions cause the computer to analyze the stream of events to reduce the number of events in the stream of events without changing the outcome of the stream of events.

In some embodiments, the instructions cause the computer to save the first image in Portable Network Graphics (PNG) format. In some embodiments, the instructions cause the computer to save information on the controls in Extensible Markup Language (XML) format.

In a further aspect, the invention provides a software tool for authoring a training simulation. The software tool provides a course developer with an ability to read information captured from a software application, including images of screens of the software application and information describing controls associated with the images, each control having properties. The software tool further provides a course developer with an ability to associate training text with the images, and to create one or more paths between the one or more images. The paths are based on actions that use the controls that are associated with the images.

In another aspect, the invention provides a software tool for authoring a training simulation for a software application, in which the tool provides a course developer with an ability to create a control associated with an image in the training simulation, the control having one or more properties. The tool also provides the course developer with an ability to specify an event that uses the control, to associate training text with the image, and to visually create a path between the image and a second image in the training simulation, the path based on the event.

In another aspect, the invention provides a method of training a user to use a software application using a simulation of the software application by capturing a stream of events that occur as the user is using the software application. The stream of events is compared to paths contained within the simulation of the software application to determine whether the stream of events represents a valid way of performing a task. If the stream of events does not represent a valid way of performing a task, then the method may intervene in the use of the software application. In some embodiments, the intervention includes offering assistance to the user. In some embodiments, the intervention includes demonstrating how to perform the task.

These and other objects, advantages, and features of the invention will become apparent through reference to the following description, the accompanying drawings, and the claims. Furthermore, it will be understood that the features of the various embodiments described herein are not mutually exclusive, and can exist in various combinations and permutations.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a block diagram showing an overview of an illustrative embodiment of the system of the present invention;

FIG. 2 is a block diagram depicting the operation of a capture tool according to an illustrative embodiment of the invention;

FIG. 3 is a block diagram depicting components of an analyzer according to an illustrative embodiment of the invention;

FIG. 4 is a block diagram showing components of an author tool according to an illustrative embodiment of the invention;

FIG. 5 is an exemplary display screen depicting an object editing capability of an author tool according to an illustrative embodiment of the invention;

FIG. 6 is an exemplary display screen depicting a toolbox area in an author tool according to an illustrative embodiment of the invention;

FIG. 7 in an exemplary display screen depicting a path designing capability of an author tool according to an illustrative embodiment of the invention;

FIG. 8 is an exemplary display screen showing a path description in an author tool according to an illustrative embodiment of the invention;

FIG. 9 is an exemplary display screen showing the specification of multiple paths in an author tool according to an illustrative embodiment of the invention;

FIG. 10 is an exemplary display screen showing another example of multiple paths specified in an author tool according to an illustrative embodiment of the invention; and

FIG. 11 is an exemplary display screen depicting a content authoring capability of an author tool according to an illustrative embodiment of the invention.

### DESCRIPTION

The present invention provides a set of tools and methods to facilitate the creation of training simulations for computer applications. Generally, the invention permits a course developer or author to create a working simulation of various aspects of an application, and to add training text, such as user prompts and feedback to the simulation. These training simulations are provided to end users, who use them to learn how to use the applications for which the training simulations were prepared.

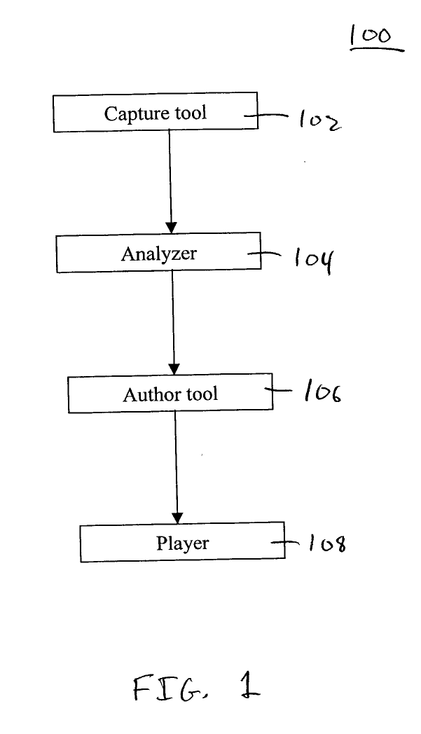

Referring to FIG. 1, an overview of an illustrative embodiment of the present invention is described. In broad overview, a system 100 according to the present invention includes a capture tool 102, an analyzer 104, an author tool 106, and a player 108.

The capture tool 102 facilitates the production of application graphical user interface (GUI) simulations by capturing screen images and other relevant data, such as controls and events from the target application and operating system, while a course developer is performing a desired set of steps for a particular task. In addition to capturing an image of the screen of the target application, the capture tool 102 captures controls that appear on the screen, including various properties and data associated with the controls.

As used herein, a screen of an application can be any window, screen, dialog box, or other portion of a display that is controlled, drawn, or associated with a particular application. For example, for an application running under the Microsoft Windows operating system, the screen may be the main window of the application, but may not include other windows or portions of the display that are controlled by other applications.

As used herein, a control can be an object that appears on the screen of an application, and is typically used to facilitate interaction with a user. In applications running under the Microsoft Windows operating system, for example, controls may include buttons, edit boxes, check boxes, scroll bars, list boxes, or other objects that appear on the screen of an application.

These controls typically include numerous properties, such as location on the screen, width, height, font information, information on whether the control is enabled, information on the type of cursor that appears when a user moves the cursor or pointer over the control, and other information relating to the display and operation of the control. Controls may also include data items, such as whether a checkbox is checked or not, or the text that has been entered into an edit box.

In addition to capturing the controls on a screen, the capture tool 102 may capture the events that occur while the course developer is interacting with the application. This event information may include various mouse and keyboard events that occur between screen captures.

The information gathered by the capture tool 102 is saved in a file, and may be used, after analysis and authoring, to provide animation and user interaction to train an end user to use the application from which the screen images, controls, and events were captured.

Analyzer 104 provides a set of processes that analyze the captured data and build a simulation of the task performed. Among the goals of the analyzer 104 is to reduce the authoring and engineering tasks that are needed to produce or author a training simulation. The analyzer 104 performs tasks such as analyzing the events captured by the capture tool 102 to extract high-level events, and to determine the flow of the simulation.

The author tool 106 provides a visual development environment to a course developer. The author tool 106 generally permits a course developer to view the course simulation as it will appear to the end user, add scenario information, user prompts and feedback, and modify simulations, including the properties and data of controls. The author tool 106 further permits a course developer to specify one or more paths through the simulation that may be selected depending on the actions of an end user.

When the course developer has finished creating a simulation, the author tool 106 saves the simulation, including screen images, controls, paths, scenario text, prompt text, feedback text, and any other information that may be used for the simulation.

A player 108 is used by end users to play back the simulations and use the simulations that have been created using the capture tool 102, the analyzer 104, and the author tool 106. The player 108 reads information that was saved by the author tool 106 to run a simulation of an application user interface for end user training. The player 108 may be a standalone application, or may be a tool, such as a Java applet, that permits the end user to use a Web browser to run a simulation.

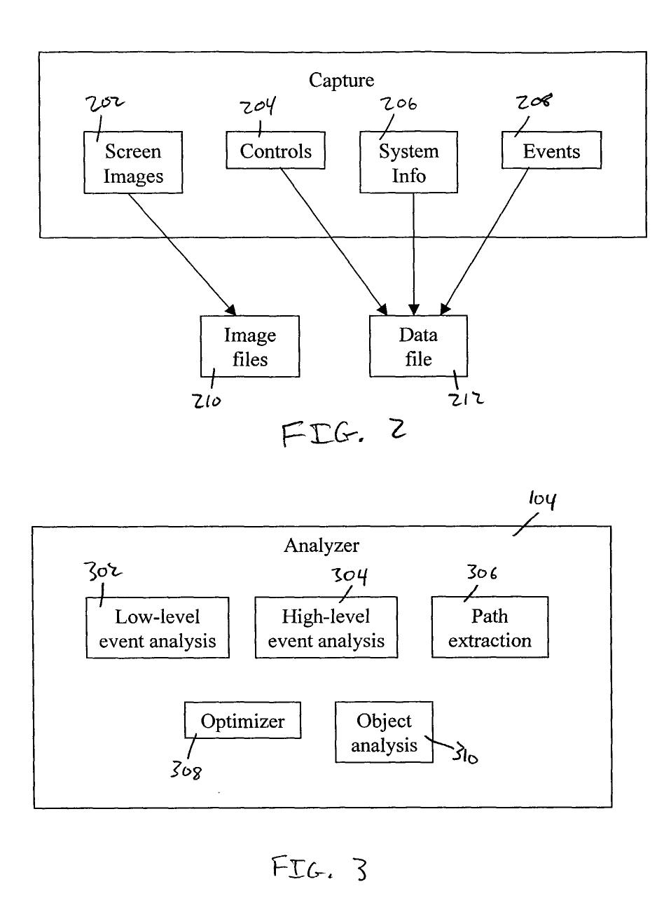

Referring now to FIG. 2, the operation of the capture tool 102 is described. The capture tool captures screen images 202, controls 204, system information 206, and events 208. The information that is captured is stored in image files 210 and a data file 212. This capture process takes place as a course developer is using an application to perform tasks, capturing the screen and controls at “capture points.” Information on events is typically gathered continuously once the capture process starts, and can be used to determine the set of event that occur to between one capture point and the next.

Generally, the capture tool 102 may operate in an automatic mode, in which the capture points may be automatically determined, or a manual mode, in which the course developer who is running the capture tool 102 determines when the capture points will occur. In the manual mode, the course developer determines when capture points will occur by taking a specific action, such as pressing a particular key. In the automatic mode, the capture tool 102 may capture images and/or controls when any of a number of actions or events is detected. For example, the capture tool 102 could automatically capture images and/or controls when a particular “hot key” is pressed, when a new window is created or destroyed, when a window is activated, when a window is “repainted”, when user events occur, when the state of a window changes, or when a menu is selected. The set of actions or events that will cause an automatic capture may be specified by a user of the capture tool 102.

When a capture point occurs, the capture tool 102 may capture a screen image 202. A screen image 202 is captured by capturing the bitmap of the portion of the display that represents the screen of the application. The bitmap representing the screen image is saved in an image file 210. In an illustrative embodiment of the capture tool 102, the image file 210 is in a standard image file format, such as the Portable Network Graphics (PNG) format.

The capture tool 102 may also capture the controls 204 on a screen of an application when a capture point occurs. Generally, the controls 204 that are captured include window based controls, such as buttons, edit boxes, check boxes, scroll bars, list boxes, tool bars, and other standard controls. The capture tool 102 may also capture objects such as the system menu, or non-standard or windowless controls. Other objects, such as Web controls or Java controls may also be captured. For example, in an embodiment of the capture tool 102 running under the Microsoft Windows operating system, the capture tool 102 may capture the standard controls provided in the Microsoft Windows operating system, as well as Java controls, and Web controls in the Microsoft Internet Explorer (version 5.5 or higher) Document Object Model (DOM).

For window based controls, capturing a control includes capturing a variety of properties associated with the control. For example, for controls in an application that runs under the Microsoft Windows operating system, the properties captured may include a window handle, a window class name, menu information, window style, font data, color information (e.g., foreground color and background color), a window caption, child information, rectangular bounds (e.g., left, top, height, and width), tooltip information, tab order, and a module file name.

Additionally, depending on the type of control, additional properties and data items may be captured. For example, for a button control, the button style information may be captured, as well as the current state of the button (e.g. does the button have focus). For an edit box, the style of the edit box and the state of the edit box may be captured. For other types of controls, properties specific to those controls may be captured. Additionally, data items associated with controls, such as the content of an edit box, or whether a checkbox is checked or unchecked may be captured. Note that in some embodiments, these data items may be included in the properties that are captured.

In some cases, such as for windowless controls, or controls that are not standard, the information captured may be limited. In some cases, the capture tool 102 may be able to capture properties such as the rectangular bounds of the control, or limited state information. In some extreme cases, it may be possible for capture tool 102 to capture only an image of a non-standard or windowless control.

The controls 204 captured by the capture tool 102 are saved to a data file 212. In an illustrative embodiment of the capture tool 102, the data file 212 is an Extensible Markup Language (XML) file. In some embodiments, all the controls captured at all the capture points are stored in a single data file 212. In other embodiments, a new data file 212 is created for each capture point. Other embodiments may split the data file 212 into multiple files if the size of the data file 212 exceeds predetermined thresholds.

In addition to capturing screen images and controls, the capture tool 102 captures a variety of system information 206, such as whether a mouse is installed, whether double-byte characters are supported, or whether a debugging version of the operating system is installed. For the Microsoft Windows operating system, the system information 206 may further include the dimensions of various display elements, system colors, window border width, icon height, and so on.

The system information 206 may be captured once, when the capture tool 102 starts capturing, or may be captured at some or all of the capture points. Typically, the system information 206 will be stored in the data file 212. In an illustrative embodiment, the system information 206 is stored in XML format in the data file 212. Alternatively, some embodiments may store the system information 206 in a separate file (not shown).

The capture tool 102 also captures events 208. The events 208 are continuously captured irrespective of whether the capture tool 102 is in automatic mode or manual mode. The events 208 may include events generated by a user, or events generated by the system. Generally, the events 208 determine the actions that must be taken to navigate between the screens that have been captured at the capture points.

The events 208 typically include events such as mouse movement and keystrokes. For capturing the events 208 in an application running under the Microsoft Windows operating system, system hooks are used to perform the capturing. Specifically, system hooks capture events associated with activating, creating, destroying, minimizing, maximizing, moving, or sizing a window, keystroke messages, mouse-related messages, such as mouse movement or clicks, and messages generated as a result of an input event in a dialog box, message box, menu, or scroll bar.

The events 208 that are captured by capture tool 102 are typically stored in the data file 212. In an illustrative embodiment, the events 208 are stored in XML format in data file 212. Alternatively, some embodiments may store the events 208 in one or more separate files (not shown).

In addition to capturing information, as described above, some embodiments of the capture tool 102 may provide limited playback capabilities, that can display the screens and events that have been captured. This permits a course developer to determine what has been captured, and to re-capture material if necessary.

In some embodiments, the capture tool 102 is provided as a separate application that can be placed on portable media, such as a CD-ROM or floppy disk. This permits the capture tool 102 to be used on systems that do not have the full set of course authoring tools of the system 100 available. In other embodiments, the capture tool may be a part of a larger simulation development system that includes other portions of the system 100, such as the analyzer 104 or the author tool 106.

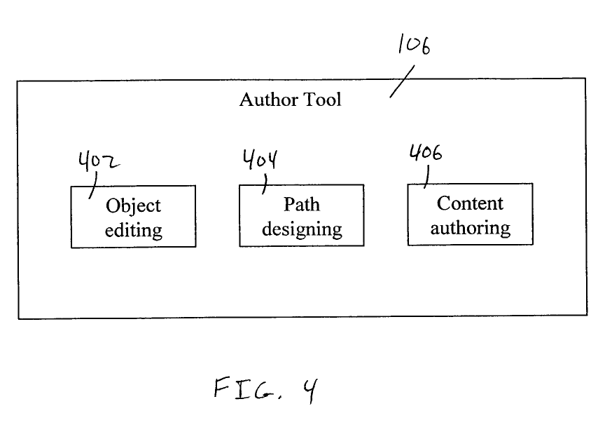

FIG. 3 shows a block diagram of the processes performed by the analyzer 104. The analyzer 104 includes low-level event analysis 302, high-level event analysis 304, path extraction 306, and optimizer 308, and object analysis 310. In some embodiments, the analyzer 104 is integrated into the author tool 106. In some embodiments, portions of the analyzer 104 are integrated into the capture tool 102.

The low-level event analysis 302 optimizes portions of the event stream by removing unnecessary or redundant information. For example, if during the process of capturing events, the course developer typed text in an edit box, made a mistake, used the “backspace” key to remove the mistake, and typed new text, then the low-level event analysis 302 would remove the keystroke events for the material that was backspaced over and the backspace keyboard events, and keep only the keyboard events representing the final text that appears in the edit box. Similarly, extraneous mouse movements can be removed, creating more direct mouse paths to a control or object that is being selected. Additionally, events may have been captured that will have no effect, or that may otherwise be discarded by the low-level event analysis 302.

It should be noted that in some cases, the tasks handled by the low-level event analysis 302 could alternatively be directly handled during capturing, or could be handled by the high-level event analysis 304. For instance, the foregoing example with text typed into an edit box could be handled by recapturing the object state of the edit box at each keystroke, and then using the high-level event analysis 304 to construct a single high-level event of typing text equivalent to the final text in the edit box (prior to another event or a “leave focus” event).

In some embodiments, the low-level event analysis 302, or portions of its functionality may be integrated into the capture tool 102, and may directly affect the events that are saved by the capture tool 102.

The high-level event analysis 304 is responsible for grouping events to create more meaningful, high-level events. This is done by application of rules that relate to the specific types of events that are being captured. For example, if the high-level event analysis 304 detects a mouse click followed quickly by another mouse click, it may replace the two individual mouse click events with a double click event. High-level events include both hardware-specific events, such as mouse double clicks, and events that are related to the behavior of objects or controls, such as select, browse, focus and text events. For example, typing into a field may be captured as individual keystrokes, and then analyzed to create a single text event.

The path extraction 306 determines initial relationships between the captured screens, by connecting the screens in a “path”, in which a series of events link one screen to the next screen. Most of this path information is present following the capturing of screens and events, but the path extraction 306 may modify the links between screens in cases where the analyzer 104 determines that screens or events should be eliminated. These paths and the ways in which they may be used will be described in greater detail below.

The optimizer 308 performs optimization on the captured information by discarding redundant information to reduce the size of the files and to simplify the authoring process. The optimizer 308 may discard screen captures that may be unnecessary. Additionally some objects, such as screen images or controls may be represented in terms of their changes. For example, if two adjacent screen images only differ within a small region, it may be useful to save only the changes between the screens, rather than the entire images of both screens. As another example, when objects or controls, such as toolbar items or menus are disabled or enabled, or appear or disappear on adjacent pages, some of these changes may be represented as modifications to existing objects or controls. This may permit the system to eliminate redundant captured control information.

The object analysis 310 analyzes each of the objects or controls that were captured to determine additional information or properties of the objects or controls. This analysis is performed using a set of rules and heuristics. For example, if an unnamed field appears to the immediate right of a label, the name of the field may be inferred from the text in the label. Additionally, in some embodiments, object analysis may be able to associate properties, such as rectangular bounds, with rectangular areas of the screen for which no control properties were able to be extracted.

When the analyzer 104 has completed its analysis, the screens, controls, system information, events, and any other information that has been captured or that has resulted from analysis of the captured information is used in the author tool 106 to complete the creation of a training simulation.

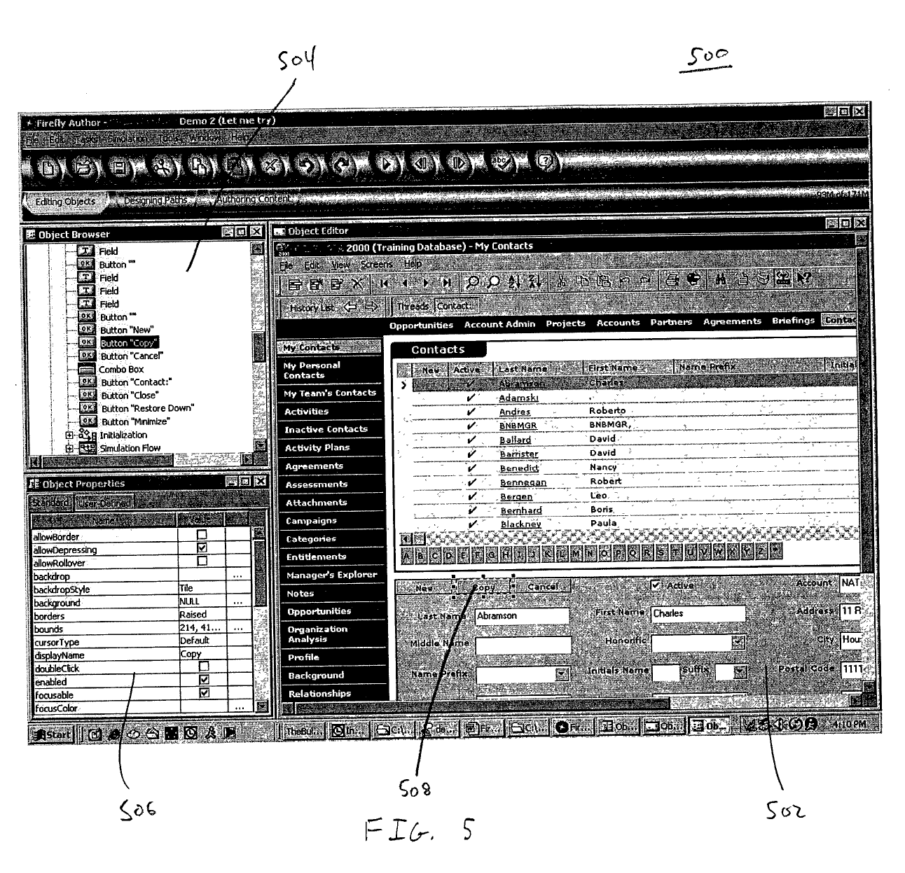

As seen in FIG. 4, the author tool 106 includes an object editing capability 402, a path designing capability 404, and a content authoring capability 406. The author tool 106 receives information on screens, controls, events, system information, and preliminary information on paths from the analyzer 104. A course developer then uses the author tool 106 to add instructional content and to edit paths and controls to create a complete training simulation. Advantageously, because this process is handled by tools with easy-to-use graphical user interfaces, it is not necessary for a course developer to be able to write programs to create a training simulation.

The object editing capability 402 provides a course developer with the ability to view and edit the controls that were captured on a screen. Because the capture tool 102 captured all of the properties associated with the controls, the object editing capability 402 permits a course developer to alter the properties and data associated with controls. The course developer can change the properties or data of controls, move controls, delete controls, and add new controls to a screen.

The object editing capability 402 also typically provides the course developer with the ability to set the initial state of screens. For example, in setting the initial state of the controls on a screen, the course developer could set the initial text of a field, change the default item in a combobox control, change whether checkboxes are checked, and so on. The course developer can also select the initial focus. For example, the course developer could set the initial focus in a screen to an edit box, and specify that the text in the edit box is initially selected, so that when a user types, the original text in the edit box will be overwritten.

Advantageously, since the controls were captured separately from the graphical image of the screen, setting the initial state of a screen and other editing of the controls can be done without requiring that a screen be recaptured, or that the image of the screen be edited. Because the controls are effectively in their own layer, separate from the image of the screen, changes to the controls may be made without requiring changes to the screen image.

Generally, all the captured properties of controls can be edited, including their back-to-front position with respect to other controls, or their “tab order” (i.e. the order in which controls receive the focus when the user tabs through them). This permits a course developer to create a highly interactive simulation of an application that imitates much of the functionality of the original application's GUI, without requiring programming or rebuilding the GUI of the application.

In some embodiments, the object editing capability 402 includes the ability to create new objects or controls, including entire screens. This permits a course developer can create screens that were not originally part of any application for inclusion in a simulation. For example, a course developer could create a blank screen, and add objects and controls, text, and paths, to create portions of a simulation (or even entire simulations) that do not use captured images, controls, or objects.

In some embodiments, the object editing capability 402 includes the ability to group and save objects or controls separately for screens or other simulation elements, so they may be imported and used in other simulations. In some embodiments, an ability to detect rectangular objects in a screen bitmap is included, so that controls corresponding to those rectangular areas can be precisely positioned.

The path designing capability 404 permits a course developer to specify and edit the paths between screens in an application simulation. Generally, each path is associated with an event or series of events that will either be performed by a user, or shown by the system prior to showing the next screen in the path. The path designing capability 404 permits a course developer to change the events that cause a transition from one screen to the next by, for example, recording a set of actions taken by the course developer, and associating that set of actions (i.e., events) with a path between screens.

The path designing capability 404 permits a course developer to specify multiple paths between screens. These paths may include multiple paths from one screen to the next when, for example, there are multiple different events that will cause a similar change in the state of an application. The multiple paths can also be configured so that each path leads to a different screen, some paths cause screens to be skipped, or so that some paths lead back to earlier screens. In some embodiments, a path may be a “failure” path, which is followed if an action is taken by an end user that does not conform to one of the other sets of events or actions associated with the other paths from a screen.

When multiple paths through the simulation are used, the course developer may specify that one of the paths is the “primary” path. The primary path will be followed when an end user is shown the actions that must be taken, rather than taking the actions himself, or when the end user clicks the forward arrow to advance to the next screen.

Generally, the path designing capability 404 permits paths to be added, deleted, edited, or redirected. Because paths may lead to alternate screens, the path designing capability 404 permits captured screens, controls, and paths to be imported, and added into the training simulation. Additionally, by using the object editing capability 402, a course developer can create new screens, that were not originally captured, and may create paths using these new screens.

In some embodiments, the paths need not necessarily cause a transition from one screen to another screen. In some embodiments, a path may also lead to a “node” that causes a user prompt or feedback message to be displayed, rather than causing the display of a new screen. In some embodiments, a path may not be associated with any event. Such “no event” paths will be followed if the end user selects a “forward arrow” tool that is part of the system that executes the training simulation, without taking any action in the simulated application.

In some embodiments, in addition to being associated with a particular set of actions or events, paths may be associated with a set of actions to be taken by the system when a path is traversed. These system actions may, for example, include a timed delay before showing the next screen or may automatically trigger a “show me” event, so that multiple pages of “show me” events can be chained together to be viewed by the end user as one continuous event. Other example system actions may include playing a sound or other multimedia file, or displaying a message.

The content authoring capability 406 permits a course developer to associate various prompts and feedback text with a screen, to provide instruction. In addition to instructional text, some embodiments permit sound, graphics, animation, movies, or other multimedia content to be included in the scenario, and in user prompt and feedback messages. Typically, a spelling checker is included in the content authoring capability 406, to assist content developers. Additionally, the content authoring capability 406 may provide an ability to import text, graphics, or multimedia content from external sources.

Scenario text is generally shown at the start of a scenario on which a end user is being trained, before the first screen is displayed. Typically, the end user may refer to the scenario text at any time during training on a particular scenario. Scenario text may also include text (or other multimedia) that is displayed when a scenario is completed. This type of scenario text may be referred to as summary text, and may occur at the end of a simulation, at the end of a scenario, or at the end of a particular step in a task. Generally, scenario text may be included in any of the modes of interaction described below.

The type of text to be added to a training simulation depends on the modes of interaction that the content developer or author wishes the simulation to support. Generally, a system according to the present invention may support numerous modes of interaction, including a “show me” mode, a “teach me” mode, a “let me try” mode, and a “test me” or “assessment” mode. Some embodiments may support other modes, such as a “let me explore” mode.

In the “show me” mode of user interaction, the system will provide a self-paced demonstration of a set of steps for a particular task in an application, accompanied by user prompts. End users may read the user prompts, and watch a demonstration of each step in a task. In the “show-me” mode, the end user views a demonstration, and there is little or no interaction between the training simulation and the end user. To support the “show me” mode of interaction, the course developer may specify user prompts that may be read by users. Generally, simulations that use the “show me” mode follow only the primary path through the simulation. In some embodiments, a course developer is able to generate a movie file, such as a Quicktime movie file, from a “show me” application simulation.

In the “teach me” mode of interaction, the system will provide an end user with the ability to actually carry out the steps of a task. The system will display a user prompt (which may be different than the prompt displayed in the “show me” mode), and then permit the user to operate the simulation, with “live” controls that actually behave in the expected manner. If a user takes incorrect actions, the system may display feedback messages. The user may see a demonstration of the correct actions at any time. To support the “teach me” mode, the course developer may use the content authoring capability 406 to enter scenario text, user prompts, feedback messages, and text messages associated with particular controls or events.

In some embodiments, multiple feedback messages may be specified for each user prompt, so that the first time an end user takes an incorrect action, a first feedback message is displayed, the second time an incorrect action is taken causes the display of a second feedback message, and so on. Eventually (typically after three failures), the system may automatically demonstrate the correct action. Typically, a “teach me” simulation will follow the primary path, but in some embodiments, a failure path may be followed if a user takes incorrect actions, or alternate paths may be followed to vary the lesson, based on the actions taken by the end user.

Feedback also may be associated with individual objects or controls, and may be triggered when an end user interacts with these objects or controls if the objects or controls are not along a correct path.

In a “let me try” simulation, the system will display user prompts, instructing the user to complete the steps of a task. The user then interacts with the simulation, in which all the controls are “live”, and behave in the expected manner, to complete the task. Incorrect actions may cause the system to display feedback messages, or may send the end user on an alternative path through the simulation. The “let me try” mode of interaction typically provides a more open, practice-oriented method of interaction than the “teach me” mode. To support the “let me try” mode of operation, the course developer may user the content authoring capability 406 to enter specialized prompt messages for the “let me try”: mode, and may also enter one or more feedback messages that may be displayed when an end user takes incorrect actions.

In the “test me” or “assessment” mode, the system displays specialized user prompts. No feedback is typically given in the “assessment” mode, and demonstrations are not available. End users may be given a limited number of tries to successfully complete each task. Additionally, when a simulation is run in “assessment” mode, the results of the assessment may be reported to an instructor, or to a learning management system. To support operation in the “assessment” mode, the course developer may use the content authoring capability 406 to write specialized “assessment” mode user prompts.

Other modes of interaction, such as a “let me explore” mode, in which an end user may explore the live simulation by using the “live” controls, without specific prompts of feedback, may also be supported by adding general instructional text into a simulation using the content authoring capability 406.

In addition to providing feedback text, content authoring capability 406 provides a course developer with the ability to associate text (or other multimedia) with a control or event. For example, a text message can be triggered by moving the cursor over a particular object on a screen, be selecting a particular control, by typing particular text into an edit box. In general, any control, object, or event may be associated with the display of a text or multimedia message.

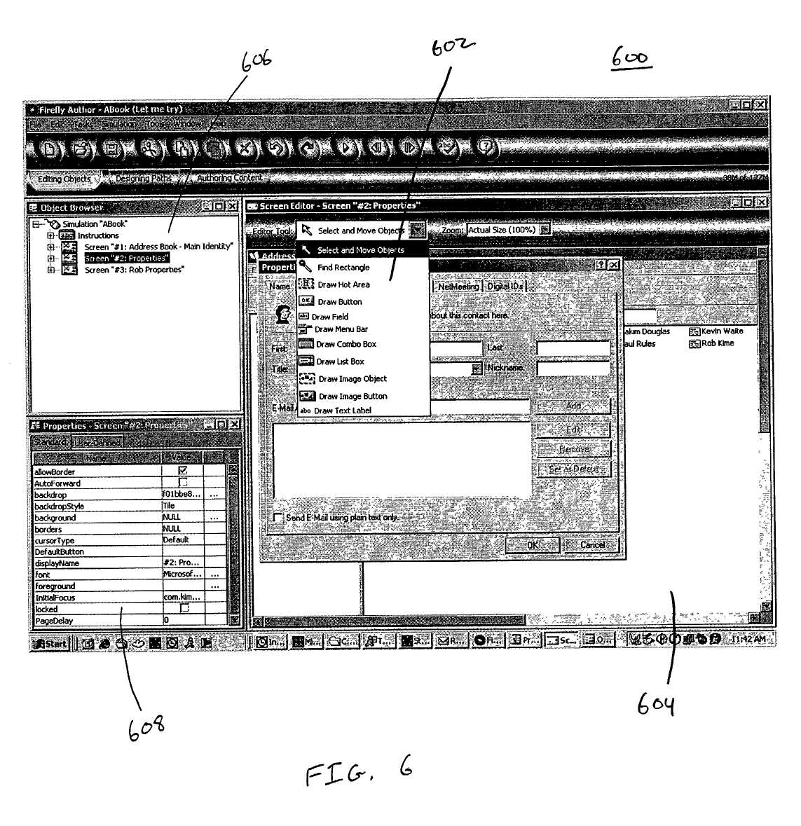

FIG. 5 shows a display 500 of the author tool 106, in which the tool is being used to support the object editing capability 402. This is done by displaying an object editor window 508, in which the captured screen and the controls on the captured screen are displayed, an object browser window 504, in which a list of the controls and other objects in the screen is provided, and an object properties window 506, in which a list of properties and data items associated with a particular control are listed.

In the example shown in FIG. 5, a button control 508, labeled “copy” has been selected in the object editor window 502, and is also highlighted in the object browser window 504. The control may be moved by dragging it to the desired location in the object editor window 502. The button control 502 may also be deleted from the simulation. By entering new values for properties and data items in the object properties window 506, the properties or data items associated with button control 508 may be edited.

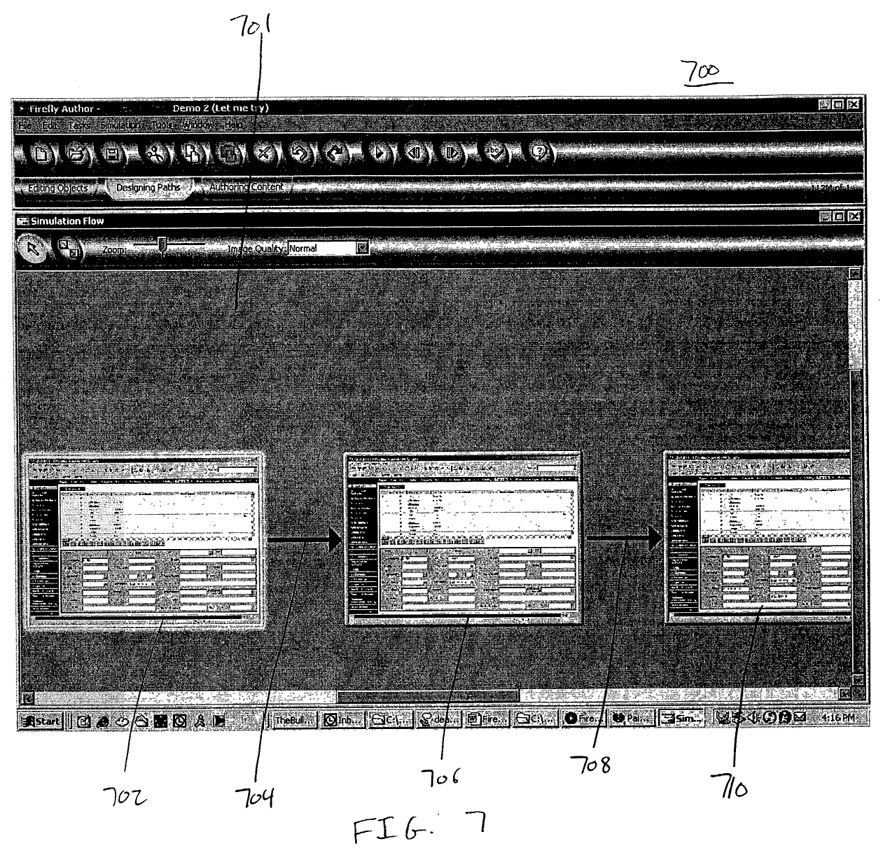

As shown in FIG. 6, to add a new control or object to a training simulation, a toolbox area 602 is used. The toolbox area 602 includes all of the different types of controls that may be added to a simulation. The course developer specifies the type of control he wishes to add using toolbox area 602, and then places the new control on the screen shown in the object editor window 604. When the new control is added, an entry for the new control will be added to the object browser window 606, and the properties and data items for the new control will be displayed (and may be edited) in object properties window 608.

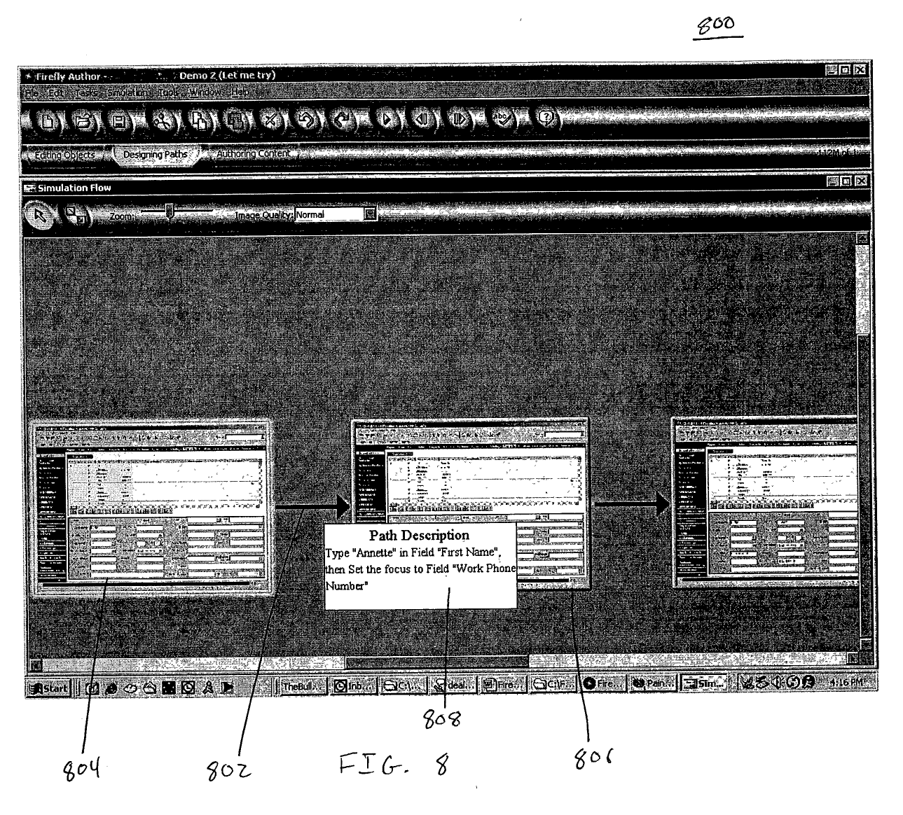

FIG. 7 shows a display 700 of the author tool 106, in which the path designing capability 404 is being used. A path 704 provides a transition between a screen 702 and a screen 706, and path 708 provides a transition between the screen 706 and a screen 710. Each of the paths 704 and 708 are associated with events or actions that are taken by a user. Since the paths 704 and 708 are the only paths from the screens 702 and 708, respectively, they are both primary paths.

The screens and paths between them appear in a simulation flow window 701, which permits a course developer to zoom in or out, to display more screens and paths. The course developer may also edit paths, add paths, and delete paths and screens in the simulation flow window 701 to create or edit a flow for the simulation. By selecting a screen in the simulation flow window 702, the course developer can switch to a display such as that shown in FIG. 5, in which the individual controls on a screen may be edited.

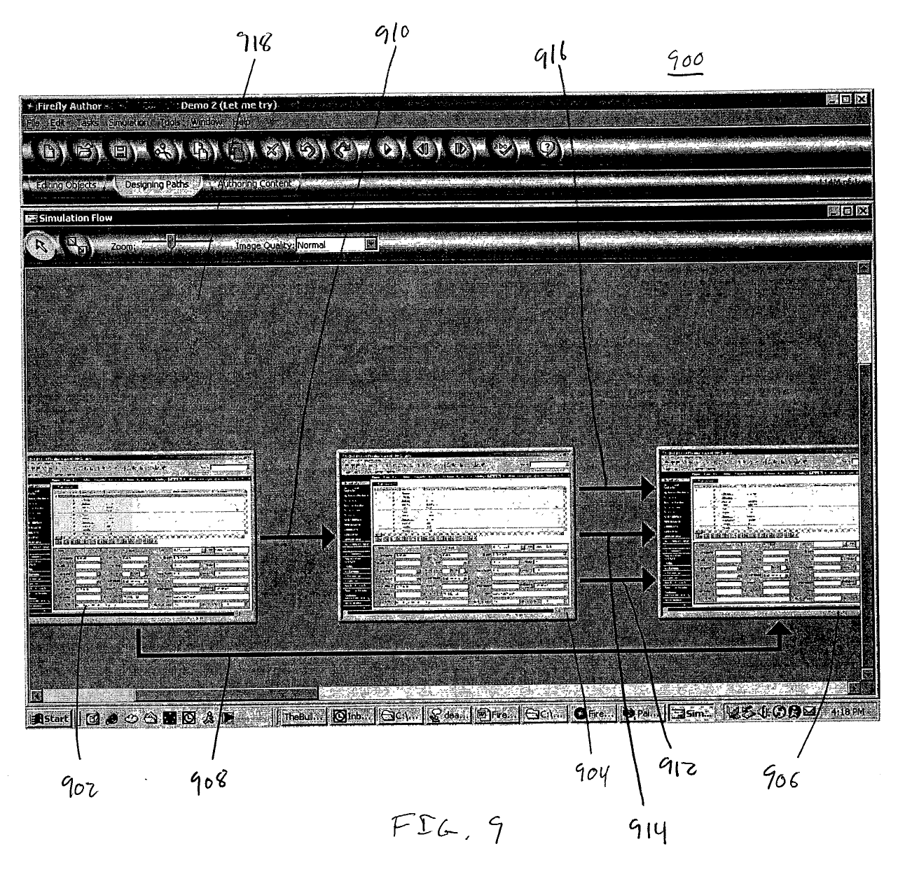

In FIG. 8, a display 800 is shown in which the event or action of a path 802 that transitions between a screen 804 and a screen 806 is displayed in a path description window 808. In this case, the event involved typing “Annette” in the field (i.e. a control) “First Name”, and then setting the focus to the field “Work Phone Number”. The path may be followed by a user taking the specified actions, or, in a “show me” mode, the system may demonstrate the specified actions before transitioning to the screen 808.

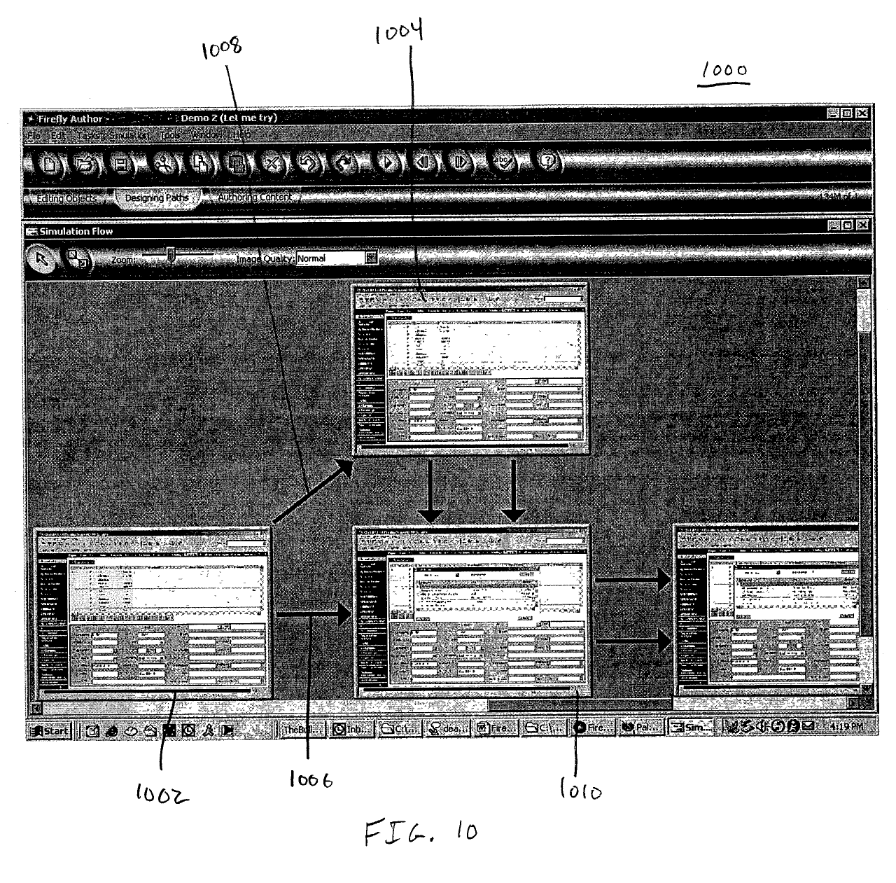

In FIG. 9, multiple actions from each of screens 902 and 904 are shown. There are two paths from the screen 902—paths 908 and 910. If a first action, specified in the path 910 is performed, then the path 910 will transition the simulation from the screen 902 to the screen 904. If a different action, as specified in the path 908 is performed, then the simulation will transition from the screen 902 to the screen 906. This type of alternate path is referred to as a “skip” path, because one or more screens may be skipped, depending on the actions of the end user.

It should also be noted that there are three paths—paths 912, 914, and 916 between screens 904 and 906. Each of paths 912, 914, and 916 specifies a different action or sequence of events, but all three such actions or sequences of events cause the simulation to transition from the screen 904 to the screen 906.

Paths 910 and 914 are primary paths, and will be followed, with the appropriate sequence of actions or events being performed by the system, in “show me” mode. In some embodiments, these primary paths may appear in a different color, to distinguish them from other paths in the simulation flow window 916.

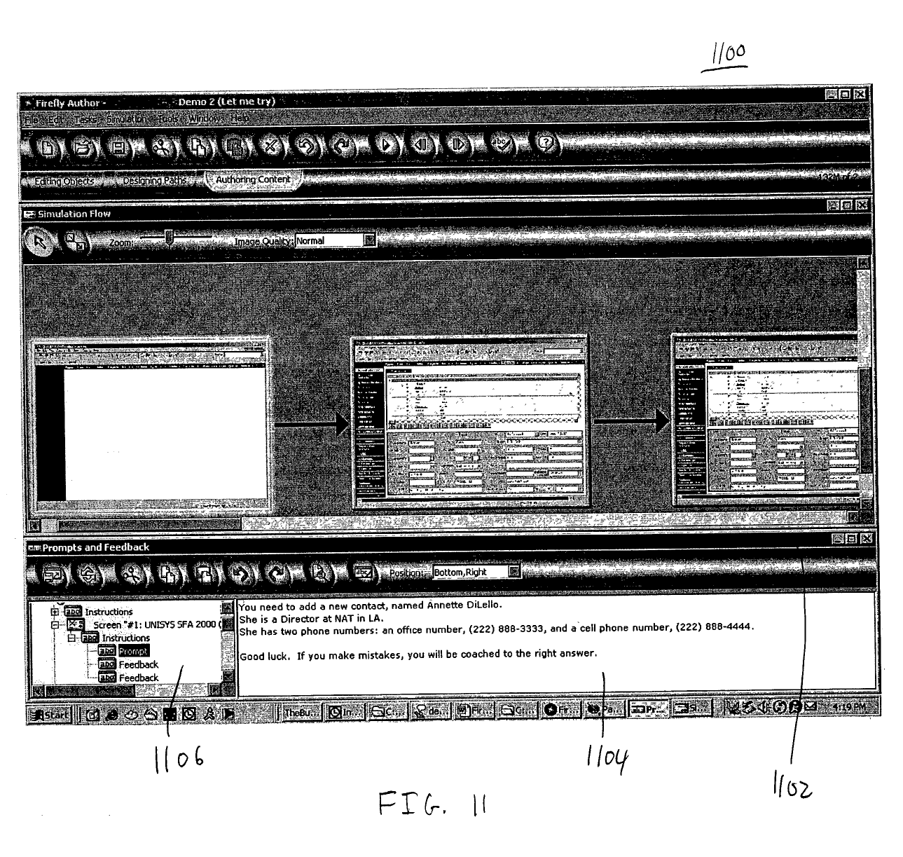

FIG. 10 shows another example of multiple paths. In FIG. 10, a path 1006 transitions the simulation from a screen 1002 to a screen 1010 if a particular sequences of actions or events are performed. A path 1008 will cause the simulation to switch from the screen 1002 to a screen 1004 if a different sequence of actions or events (specified in the path 1008) occurs.

FIG. 11 shows display 1100 of the author tool 106, in which content authoring capability 406 is being used by a course developer. Display 1100 includes prompts and feedback window 1102, in which user prompt text associated with a screen may be edited by a course developer in text area 1104. The prompts and feedback window 1102 includes a list section 1106, in which the specific prompt or feedback to be edited may be selected or added. In the example shown in FIG. 11, as shown in list section 1106, the prompt being edited in text area 1104 is associated with a screen called “Screen #1”, and is part of the “Instructions” for that screen. The screen may have other prompts and feedback associated with it, depending on the modes of interaction that the course developer has decided to use.

Once the course developer has completed work on the training simulation in author tool 106, the entire simulation is saved to a file that may be redistributed to end users. In some embodiments, the file containing the simulation is compressed, so that training simulations may be easily distributed on portable media, or quickly downloaded over a network. In some embodiments, the mode of interaction is specified at the time the simulation is saved (i.e., it may be saved as a simulation of any mode for which the needed prompts, etc. have been added).

In some embodiments, the author tool 106 permits the course developer to export simulations to various forms and constructions of the Hypertext Markup Language (HTML), or in other file formats. As mentioned above, some embodiments may provide the ability to export “show me” simulations as movies.

The training simulations are executed by end users using the player 108, which displays the screens in the simulations, displays and operates the controls, displays the user prompts and feedback, and takes the actions specified in the simulation depending on the actions taken by the user, and the interaction mode. Thus, the player 108 effectively provides a small interpreter or run-time system for executing simulations produced by the author tool 106.

In some embodiments, the end user is able to select a mode from the supported interaction modes, in which to run the simulation. Other embodiments allow the end user to use only the interaction mode in which the simulation was saved. The player 108 is typically a separate application. In some embodiments, the player 108 is implemented as a Java applet, permitting simulations to be executed within a Web browser, without requiring that the user of the simulation actively download or install any additional software to run training simulations.

The capture tool 102, analyzer 104, and author tool 106 may be used for purposes other than creating training simulations. For instance, the simulations could be used for application modeling. Additionally, these tools may be used in various configurations to permit alternative uses of the tools. For example, the capture tool 102, the analyzer 104, and the author tool 106 could be used for tracking user behavior, or for help desk support, to track user errors for better troubleshooting. In these cases, the capture tool 102 may send a stream containing controls, events, and other captured information across a network to the analyzer 104 or to the author tool 106, rather than saving the captured information as a file.

Additionally, the capture tool 102 and the player 108 may be used in a “live” mode to provide training and hints within an application. In this mode, capture tool 102 is used to monitor the actions of an end user in an application. The stream of events that are captured by the capture tool 102 are sent to the player 108. Because the player 108 knows the flow of events based on the simulation that was prepared using the author tool 106, the player 108 is able to determine whether the end user is performing a task in a valid way. If the player 108 determines, based on the monitored events and the simulation, that the end user is not performing a task within the application in a valid way, the player 108 can intervene, offering the user hints, training, or a demonstration of performing the task.

Changes may be made in the above constructions and foregoing sequences of operation without departing from the scope of the invention. Also, the above described invention may be embodied in hardware, firmware, object code, software or any combination of the foregoing. Additionally, the invention may include any computer readable medium for storing the methodology of the invention in any computer executable form.

It is accordingly intended that all matter contained in the above description or shown in the accompanying drawings be interpreted as illustrative rather than in a limiting sense. It is also intended that the following claims cover all aspects of the invention.

What is claimed is:

1. A method of authoring a software training simulation comprising:
capturing a first image of a screen of a software application;
capturing a control appearing on the screen of the software application, the control having one or more properties;
capturing a stream of events occurring within the software application, the stream of events comprising at least one event; and
associating training text with the first image.

2. The method of claim 1, further comprising analyzing the stream of events to extract a high-level event;

3. The method of claim 2, further comprising capturing a second image of a screen of the software application.

4. The method of claim 3, wherein capturing the stream of events comprises capturing zero or more events that occur between capturing the first image and capturing the second image.

5. The method of claim 4, further comprising creating a path between the first image and the second image, wherein the path includes the high-level event.

6. The method of claim 5, further comprising creating a second path between the first image and the second image.

7. The method of claim 5, wherein creating a path further comprises using a graphical user interface to specify the path.

8. The method of claim 5, further comprising capturing a third image of a screen of the software application, and creating a second path between the first image and the third image.

9. The method of claim 1, further comprising editing a property of the control.

10. The method of claim 1, wherein associating training text with the first image comprises associating a user prompt with the first image.

11. The method of claim 10, wherein associating training text with the first image further comprises associating one or more feedback texts with the first image.

12. The method of claim 1, wherein associating training text with the first image comprises associating multimedia with the first image.

13. The method of claim 1, wherein associating training text with the first image comprises associating training text with the control.

14. The method of claim 1, wherein associating training text with the first image comprises associating training text with an event.

15. The method of claim 1, further comprising associating a flow with the software training simulation, the flow including the first image, the control, and the training text, wherein the flow is at least partially derived from an event in the stream of events.

16. The method of claim 1, further comprising associating a scenario text with the software training simulation.

17. The method of claim 1, further comprising adding a second control, the second control having one or more properties.

18. The method of claim 1, further comprising saving the first image, the control, and the training text in a file.

19. A method of training a user to use a software application using a simulation of the software application, the method comprising:
displaying a first image, the first image showing a screen of the software application;
displaying a first control and a second control, the first and second controls each including one or more properties, the first and second controls displayed over portions of the first image, the one or more properties of the first control affecting the display of the first control, the one or more properties of the second control affecting the display of the second control;
displaying a training text associated with the first image;
permitting the user to perform a first action using the first control;
permitting the user to perform a second action using the second control;
displaying a second image of the screen of the software application when the user performs the first action; and
displaying a third image of the screen of the software application when the user performs the second action.

20. The method of claim 19, wherein displaying the training text comprises displaying a user prompt directing the user to perform a task, and wherein the method further comprises displaying a feedback message if the user performs the task incorrectly.

21. The method of claim 19, further comprising:
executing a recorded event that alters the state of the first control when the event is executed to show the user how to perform a task.

22. The method of claim 19, wherein displaying the first image comprises displaying the first image in a Web browser.

23. The method of claim 19, wherein displaying the training text comprises displaying a scenario text prior to displaying the first image.

24. The method of claim 19, wherein displaying the training text comprises displaying a scenario text in response to a user request.

25. The method of claim 19, further comprising reporting information relating to the progress of a user.

26. A method of training a user to use a software application using a simulation of the software application, the method comprising:
displaying a first image, the first image showing a screen of the software application;
displaying a first control, the first control including one or more properties, the first control displayed over a portion of the first image, the one or more properties of the first control affecting the display of the first control;
displaying a training text associated with the first image;
permitting the user to perform a first action using the first control;
permitting the user to perform a second action using the first control;
displaying a second image of the screen of the software application when the user performs the first action; and
displaying a third image of the screen of the software application when the user performs the second action.

27. A method of training a user to use a software application using a simulation of the software application, the method comprising:
displaying a scenario text associated with the simulation of the software application;
displaying a first image, the first image showing a screen of the software application;
displaying a first control, the first control including one or more properties, the first control displayed over a portion of the first image, the one or more properties of the first control affecting the display of the first control;
displaying a training text associated with the first image; and
permitting the user to perform a first action using the first control.

28. A system for creating a software training simulation, the system comprising:
a capture tool, the capture tool providing a course developer with an ability to:
sequentially capture one or more images of screens of a software application;
capture a plurality of controls associated with each of the one or more images, each control in the plurality of controls having one or more properties; and
capture a stream of events that occur during use of the software application; and an author tool, the author tool providing the course developer with an ability to:
associate training text with each of the one or more images; and
create one or more paths between the one or more images, the paths based on events in the stream of events that affect at least one control in the plurality of controls associated with each of the one or more images.

29. A system for creating a software training simulation, the system comprising:
a capture tool, the capture tool providing a course developer with an ability to:
sequentially capture one or more images of screens of a software application;
capture a plurality of controls associated with each of the one or more images, each control in the plurality of controls having one or more properties; and
save a representation of the plurality of controls and the one or more properties associated with each control in the plurality of controls to a file; and
an author tool, the author tool providing the course developer with an ability to:
read a file containing a representation of the plurality of controls and the one or more properties associated with each control in the plurality of controls;
associate training text with each of the one or more images; and
create one or more paths between the one or more images, the paths based on actions that use the plurality of controls associated with each of the one or more images.

30. A software tool for capturing information from a software application for use in creating a training simulation for the software application, the software tool comprising instructions that cause a computer executing the instructions to:
capture a first image of a screen of the software application;
capture one or more controls located on the screen of the software application, each of the controls including a plurality of properties; and
save information on the first image, the one or more controls, and the plurality of properties of each control for use in creating a training simulation.

31. The software tool of claim 30, wherein the instructions further cause a computer executing the instructions to capture a stream of events occurring during use of the software application.

32. The software tool of claim 31, wherein the instructions further cause a computer executing the instructions to analyze the stream of events to reduce the number of events in the stream of events without changing the outcome of the stream of events.

33. The software tool of claim 30, wherein the instructions that cause a computer to save information cause a computer executing the instructions to save the first image in Portable Network Graphics (PNG) format.

34. The software tool of claim 30, wherein the instructions that cause a computer to save information cause a computer executing the instructions to save information on the one or more controls in Extensible Markup Language (XML) format.

35. A software tool for authoring a training simulation for a software application, the software tool providing a course developer with an ability to:
read information captured from a software application, the information including one or more images of screens of the software application, and information describing a plurality of controls associated with each of the one or more images, each control in the plurality of controls having one or more properties;
associate training text with each of the one or more images; and
create one or more paths between the one or more images, the paths based on actions that use the plurality of controls associated with each of the one or more images.

36. A software tool for authoring a training simulation for a software application, the software tool providing a course developer with an ability to:
create a control having one or more properties, the control associated with an image in the training simulation;
specify an event that uses the control;
associate training text with the image; and
visually create a path between the image and a second image in the training simulation, the path based on the event.

37. A method of training a user to use a software application using a simulation of the software application, the method comprising:
capturing a stream of events that occur as the user is using the software application;
comparing the stream events to paths contained within the simulation of the software application to determine whether the stream of events represents a valid way of performing a task; and
intervening in the use of the software application if the stream of events does not represent a valid way of performing a task.

38. The method of claim 37, wherein intervening comprises offering the user assistance.

39. The method of claim 37, wherein intervening comprises demonstrating how to perform the task.
